(19) United States
(12) Patent Application Publication
(10) Pub. No.: US 2024/0069613 A1
(43) Pub. Date: Feb. 29, 2024

(54) POWERING SENSORS WITH AN EXSITIGN PROCESS CONTROL LOOP

(71) Applicant: Dresser, LLC, Houston, TX (US)

(72) Inventors: Alexey Tyshko, Philadelphia, PA (US); Mahendra L. Joshi, Katy, TX (US); Nasr Eldine Alkadi, Edmond, TX (US); Taric Mohammed Kabir, North Easton, MA (US); Harold Randal Smart, Portsmouth, RI (US); Bilal Zoghbi, Edmond, TX (US)

(21) Appl. No.: 17/899,884

(22) Filed: Aug. 31, 2022

(51) Int. Cl. G06F 1/26

(52) U.S. Cl. CPC G06F 1/26

(57) ABSTRACT

Hardware that is configured to gather data on a process line. These configurations may include devices that can connect to existing process control networks, like 4-20 mA control loops. These devices may include rechargeable power sources, for example, a supercapacitor. This power source can power a sensor or like hardware that resides in proximity to a control valve or other device on the process line. The sensor may require a power level for a short time that significantly exceeds one available from 4-20 mA current loop network. As an added benefit, the circuitry may find use to allow the power source to store power, or re-charge, at periodic intervals to ensure that the sensor can gather data regularly during the lifetime of the control valve.

### BACKGROUND

Industrial process facilities use networks to relay control signals from a central process controller to many process devices. These networks may use various standards to convey data and information. One of the oldest and widely used standards in multiple industries is 4-20 mA current loop. This standard provides reliable communication over a relatively simple two-wire cable since the 1950's. However, while uncomplicated, the infrastructure only provides a fixed, limited supply of power at the process device. This limitation may frustrate efforts to expand functionality or add new hardware in proximity to the controlled devices because any new features might require power in excess of what is available through the existing network structure. As a result, operators are loathe to adopt any equipment, even if beneficial, that would require them to invest in new infrastructure to provide adequate power local to the process devices.

### SUMMARY

The subject matter of this disclosure relates to improvements that allow operators to add new hardware on an existing industrial network. Of particular interest are embodiments of sensing hardware that can, for example, reside in proximity to process devices on a process line. This hardware may draw power from existing network infrastructure to store or recharge a local power source. A sensor may, in turn, draw power from this local power source. This design forecloses the need for any additional power infrastructure outside of the connections already available on the process line or industrial facility. This feature is beneficial because operators can adopt new, more robust data collection without the need to invest in separate power resource(s), like electrical cabling, batteries, or renewable energy sources (e.g., solar).

### DRAWINGS

This specification refers to the following drawings:

FIG. 1 depicts a schematic diagram of an exemplary embodiment of hardware for use in proximity to a process device;

FIG. 2 depicts a schematic diagram of an example of the hardware of FIG. 1;

FIG. 3 depicts a schematic diagram of an example of the hardware of FIG. 1;

FIG. 4 depicts a schematic diagram of as example of the hardware of FIG. 1, in the form of test circuitry for characterization of supercapacitor capability to periodically power a 1.4 W methane sensor; and

FIG. 5 depicts a plot of data that describes operation of the text circuitry of FIG. 4.

These drawings and any description herein represent examples that may disclose or explain the invention. The examples include the best mode and enable any person skilled in the art to practice the invention, including making and using any devices or systems and performing any incorporated methods. The drawings may use like reference characters to designate identical or corresponding elements. Methods are exemplary only and may be modified by, for example, reordering, adding, removing, and/or altering individual steps or stages. The specification may identify such stages, as well as any parts, components, elements, or functions, in the singular with the word “a” or “an;” however, this should not exclude plural of any such designation, unless the specification explicitly recites or explains such exclusion. Likewise, any references to “one embodiment” or “one implementation” should not exclude the existence of additional embodiments or implementations that also incorporate the recited features.

### DESCRIPTION

The discussion now turns to describe features of the embodiments shown in drawings noted above. These features can periodically expend energy in local storage devices to power sensors, or other data gathering devices, found adjacent or in proximity to process devices, like control valves. These new sensors can provide data complimentary to already installed sensors on-board the nearby process device. Other embodiments are with the scope of this disclosure.

The proposed design may find use in many process applications because of the prevailing use of 4-20 mA control loops. Thermal power plants take advantage of 4-20 mA control loops to control flow of fuel gas, feed water, steam, or cooling water to turbines, boilers, evaporators, and other equipment. Natural gas pipeline controls use 4-20 mA control loops to manage variable gas flows to power stations, residential communities, or industrial facilities, like refineries. Most, if not all, of these facilities use control valves with position control that requires, in part, a control signal from a central platform, like a central PLC or distributed control system (“DCS”). These platforms favor 4-20 mA control loops because of its simplicity and stability. An added benefit, though, is that the proposed design can leverage the same architecture to provide rechargeable power that can power new hardware, including the sensors disclosed herein.

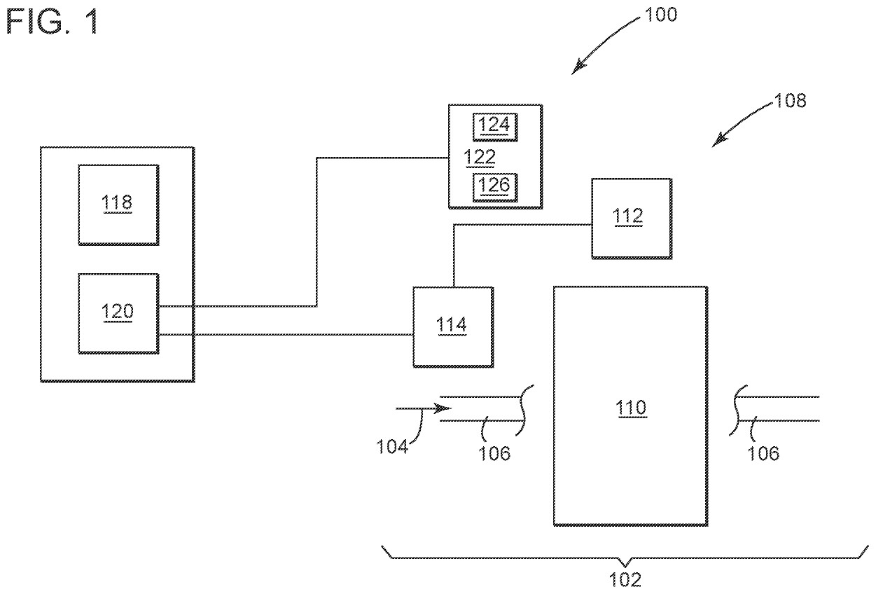

FIG. 1 depicts a schematic diagram of an exemplary embodiment of additional hardware 100. This example is part of a distribution network 102 that moves material 104 through conduit 106. A flow control 108 may be built in-line with the conduit 106. The flow control 108 may include a valve assembly with a valve 110 that couples with an actuator 112. A controller 114 may connect with the actuator 112. The controller 114 also connects to process control system 116, shown here with a process controller 118 and data exchange network 120. As also shown, the additional hardware 100 may include a sensor device 122 that connects to the data exchange network 120. The sensor device 122 may include a sensor 124 that couples with a rechargeable power source 126.

Broadly, the additional hardware 100 is configured to provide additional data or functionality. These configurations may include devices that can gather information for diagnostics, like for device-level or process line analysis. These devices may scavenge power from local storage, which may replenish or recharge during normal operation of the process line. Devices according to this disclosure, however, may draw power from available power sources, as well. This feature is beneficial because operators can avoid the need for capital investments in additional hardware.

The distribution network 102 may be configured to deliver or move resources. These configurations may find use in a vast spectrum of applications. For this example, material 104 may comprise fuel gas, steam, feed water, or cooling water; but material 104 may also comprise other gases, liquids, solids, or mixes, as well. The conduit 106 may include pipes or pipelines, often that connect to pumps, turbines, condensers, boilers, and the like. In some implementations, these pipes may form an intricate network that connects to tanks or reservoirs in industrial infrastructure or even to residential homes or commercial properties.

The flow control 108 may be configured to regulate flow throughout this infrastructure. These configurations may include devices that connect to the conduit 106. For example, the valve assembly may embody control valves, where the valve 110 may have a closure member that moves relative to a seat. Examples of the closure member may embody a plug, a ball, a butterfly, or the like. The actuator 112 may manage the position of the closure member. This device may operate on pneumatics or hydraulics, as well as with electric (or electrical) motors. The controller 114 may include devices that can provide signals to the actuator 112 for this purpose. These devices may be able to exchange and process signals, for example, to provide a pneumatic or “instrument” air signal to pneumatic actuators and electrical feedback signals.

The process control system 116 may be configured to exchange data with the controller 114. These configurations may form a control network (or “distributed control system” or “DCS”), which maintains operation of all devices on process lines to ensure that materials flow in accordance with a process. The process controller 118 may generate control signals with operating parameters that describe or define operation of the flow controls 108 for this purpose. These signals can transmit over the data exchange network 120. In one implementation, the operating parameters may define a commanded position that the controller 114 processes to generate its signal to the actuator 112. Parameters for the instrument air signal, like pressure or flow rate, may depend in large part on the commanded position for the valve assembly 110.

The data exchange network 122 may be configured to provide data and power to devices throughout a facility or industrial infrastructure. These configurations may utilize standard 4-20 mA current loop, which prevails in many industries to provide communication among and between the DCS and process devices (like flow control 108). The structure of this loop is ideal for long distances because current signals do not degrade like voltage. This structure is also less sensitive to background electrical noise.

The sensor device 124 may be configured to gather data at or proximate devices across the 4-20 mA control loop. These configurations may include devices that measure conditions or parameters, generating data that the controller 114 or DCS 118 may utilize to maintain or optimize performance of the process line. The devices may respond to changes in temperature, pressure, humidity, vibration, wind speed, and the like.

The rechargeable power source 126 may be configured to power any additional sensors. These configurations may include devices that can utilize the current signal on the 4-20 mA current loop to maintain power output. The devices may include batteries; however, in one example, a super capacitor or a plurality of super capacitors (or “capacitor bank”) is connected to the current loop to store energy. Periodic discharge from the capacitor(s) can power an adjacent sensor. This feature avoids the need for additional hardware or power infrastructure to provide power sufficient to support these expanded data gathering devices.

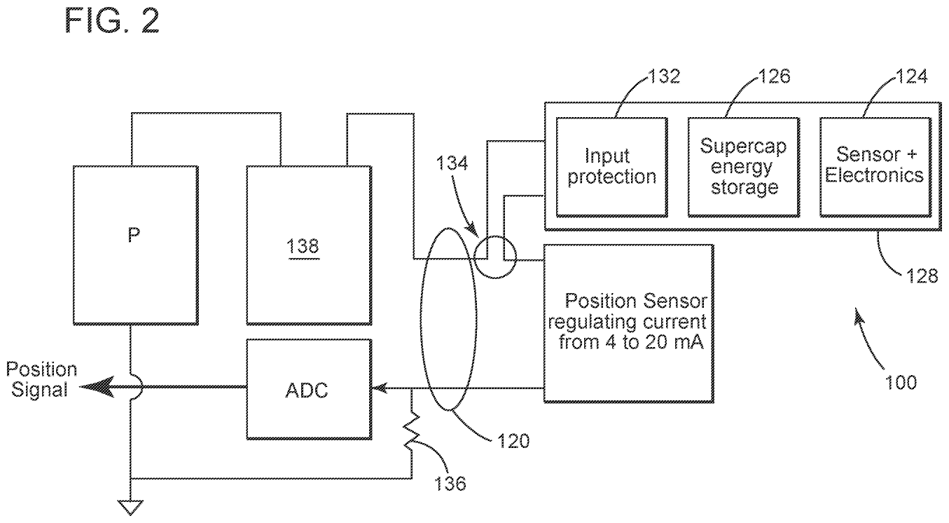

FIG. 2 depicts a schematic diagram of an example of the additional hardware 100. This example connects the sensor 124 in series with the rechargeable power source 126. Electronics 128 may help to implement this proposed design. The electronics 128 may include control circuitry 130 that can control discharge of the power source 126 to energize the sensor 124. This feature can change a state of the sensor 124, for example, from “on” to “off” and vice versa. This level of control avoids continuous draw from the power source 126. In one implementation, a protective circuit 132 may interpose between connections 134, which connect the sensor 124 with the loop 122 and available power source P. The circuit 132 may be configured to prevent over-voltage, voltage reversal or over-current events that can damage the other components in the design. The loop 122 may also include resistors 136, 138 or like hardware. The resistor 136 may convert voltage to current. The resistor 138 may limit the current to the sensor 124.

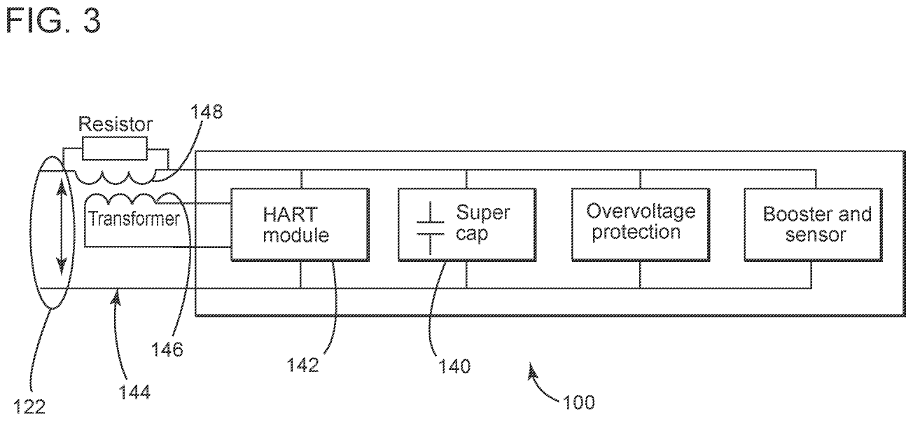

FIG. 3 depicts a schematic diagram of an example of the hardware 100. The rechargeable energy source 126 may embody a supercapacitor 140. A signal module 142 may couple with the supercapacitor 140. This device may facilitate use of HART signals; however this disclosure contemplates that the signal module 142 may accommodate other types of industrial-level control signal modalities as well. In one implementation, the design may include a transformer 144. Windings 146, 148 of the transformer 144 may couple with the signal module 142 and with the current loop 122. This arrangement may permit hardware 100 to transmit or receive HART signals. The bi-directional exchange of HART signals may serve to power multiple sensors off the supercapacitor 140.

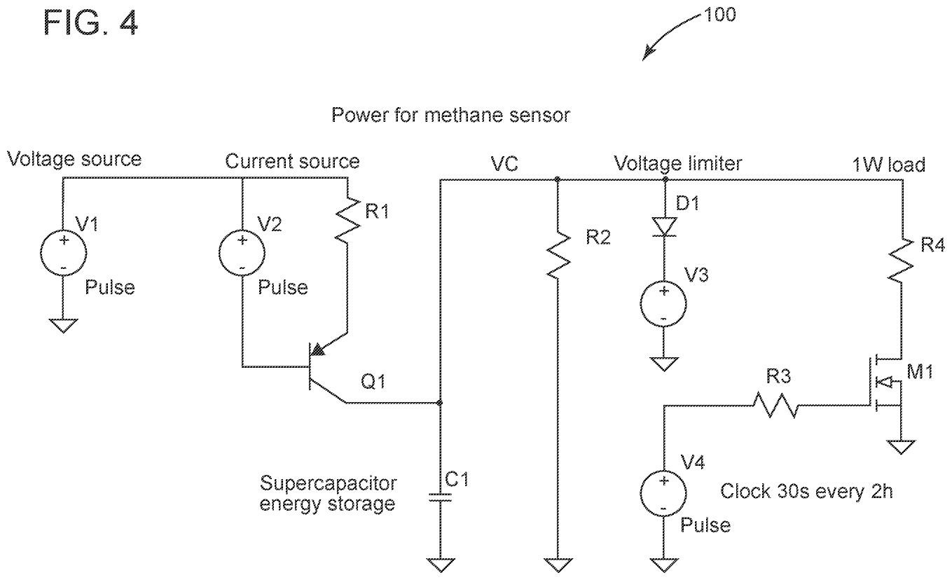

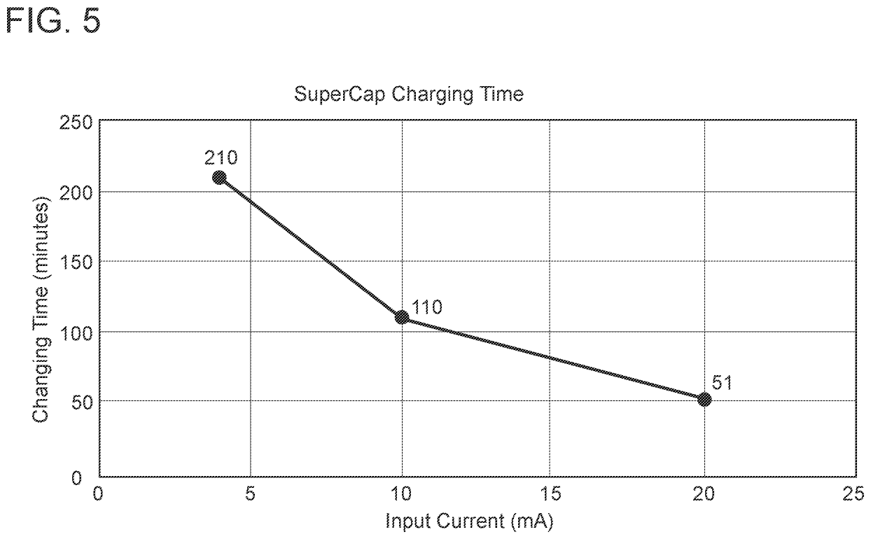

FIGS. 4 and 5 provide information for examples of the hardware 100 testing for qualification purposes. FIG. 4 depicts a schematic diagram of test circuitry for use to characterize an example of the supercapacitor 140 of FIG. 3. This test circuitry operates at a charging current of 3.6 mA and a pulsing load of 1 W. The supercapacitor 140 may embody a 60F device with a maximum voltage of 2.7 V and an operating temperature of from −40 C to 85 C. This device could provide energy to operate the sensor 124, here a methane sensor, for thirty (30) seconds every two (2) hours. FIG. 5 depicts a plot of charge time for a pair of 60F devices found on a circuit that powers a methane sensor that uses 1.4 W for eighty-four (84) seconds on a 4-20 mA loop. In operation, one implementation of the additional hardware 100 may automatically switch from “charge” mode to “discharge” mode in response to storage voltage of the supercapacitor 140. The discharge mode may, for example, activate the booster inverter to provide (or produce) power, for example, seven (7) Volts to energize the methane sensor (including its ancillary sensor heater or electronics, as necessary). The charge mode may de-activate certain electronics, like the booster inverter, to allow charge storage from the 4-20 mA loop.

In view of the foregoing, the improvements here expand functionality on a process line. The embodiments exploit existing signal infrastructure, like 4-20 mA control loops, to store charge for use at a sensor. This feature avoids capital expenditures, for example, to lay new sensor-specific power cables, add sensor-specific batteries, or to install renewal sources (like solar PV cells). Instead, the use of supercapacitor storage facilitates plug-and-play capabilities that can extend data collection to include other data that may benefit on-line diagnostics, which can improve operator costs of ownership, reduce downtime, and increase line efficiencies operator.

The examples below include certain elements or clauses one or more of which may be combined with other elements and clauses to describe embodiments contemplated within the scope and spirit of this disclosure. The scope may include and contemplate other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A sensor device, comprising:
a sensor;
a rechargeable energy source coupled with the sensor and providing a signal to activate the sensor; and
circuitry to couple the rechargeable energy source to an industrial control loop.

2. The sensor device of claim 1, further comprising:
a protective circuit interposed between the sensor and the industrial control loop.

3. The sensor device of claim 1, further comprising:
circuitry interposed between the sensor and the industrial control loop that prevents over-voltage on the sensor.

4. The sensor device of claim 1, further comprising:
circuitry interposed between the sensor and the industrial control loop that prevents over-current on the sensor.

5. The sensor device of claim 1, wherein the circuitry is configured to conduct signals from a 4-20 mA control loop to charge the rechargeable energy source.

6. The sensor device of claim 1, wherein the circuitry is configured to conduct signals from a HART control loop to charge the rechargeable energy source.

7. The sensor device of claim 1, further comprising:
a signal module coupled with the rechargeable energy source,
wherein the signal module is configured to charge the rechargeable energy source from a HART signal.

8. The sensor device of claim 1, further comprising:
a signal module coupled with the rechargeable energy source;
a transformer coupled with the signal module and the industrial control loop,
wherein the signal module is configured to charge the rechargeable energy source from a HART signal.

9. The sensor device of claim 1, wherein the circuitry activating the sensor in periodic intervals to draw power from the supercapacitor.

10. The sensor device of claim 1, wherein the rechargeable energy source is a supercapacitor.

11. A system, comprising:
a valve;
an actuator coupled with the valve; and
hardware coupled with the actuator, the hardware comprising:
a sensor device having a sensor coupled with a supercapacitor.

12. The system of claim 11, further comprising:
circuitry coupling the supercapacitor to charge using a 4-20 mA signal.

13. The system of claim 11, further comprising:
circuitry coupling the supercapacitor to charge using a HART signal.

14. The system of claim 11, further comprising:
circuitry activating the sensor in periodic intervals to draw power from the supercapacitor.

15. The system of claim 11, further comprising:
circuitry changes state of the sensor between on and off, wherein the sensor draws power from the supercapacitor in the on state.

16. The system of claim 11, wherein the sensor comprises a methane sensor.

17. A method, comprising:
directing a signal from an industrial control loop to a supercapacitor;
drawing power from the rechargeable energy source to power a sensor.

18. The method of claim 17, further comprising:
turning the sensor on and off,
wherein the signal recharges the supercapacitor when the sensor is off.

19. The method of claim 17, wherein the signal is a 4-20 mA signal.

20. The method of claim 17, wherein the signal is a HART signal.
